(19) United States
(12) Patent Application Publication
(10) Pub. No.: US 2019/0273831 A1
(43) Pub. Date: Sep. 5, 2019

(54) INFORMATION PROCESSING APPARATUS, INFORMATION PROCESSING METHOD AND NON-TEMPORARY RECORDING MEDIUM

(71) Applicants: KABUSHIKI KAISHA TOSHIBA, Tokyo (JP); TOSHIBA TEC KABUSHIKI KAISHA, Tokyo (JP)

(72) Inventor: Shinji OHIRA, Mishima (JP)

(73) Assignees: KABUSHIKI KAISHA TOSHIBA, Tokyo (JP); TOSHIBA TEC KABUSHIKI KAISHA, Tokyo (JP)

(21) Appl. No.: 15/909,914

(22) Filed: Mar. 1, 2018

(51) Int. Cl. H04N 1/00

(52) U.S. Cl. CPC H04N 1/00352; H04N 1/00506; H04N 1/00429

(57) ABSTRACT

An information processing apparatus includes a display controller and an input section. The display controller displays an explanation screen for displaying information indicating an operation method of an image forming apparatus and an operation screen for receiving an input instructing an operation relating to an image forming processing of the image forming apparatus on a display section. The input section receives an input of an operation of selecting information displayed on the explanation screen. The display controller displays an operation screen according to the selected information on the display section.

### FIELD

Embodiments described herein relate generally to an information processing apparatus, an information processing method and a non-temporary recording medium.

### BACKGROUND

An image forming apparatus displays a screen for displaying information indicating an operation method and an operation screen which is a user interface for operating the image forming apparatus on a display section. In general, there are many cases in which there is a plurality of operation screens displayed in such an image forming apparatus. In this case, a user needs to find out an operation screen for instructing a desired operation to the image forming apparatus from the plurality operation screens. In the conventional image forming apparatus as described above, much time and labor is taken for the user thereof.

### DESCRIPTION OF THE DRAWINGS

FIG. 1 is a schematic diagram illustrating an outline of a system configuration of an image forming system according to some embodiments;

FIG. 2 is a diagram illustrating a specific example of hardware components of a user terminal according to some embodiments;

FIG. 3 is a diagram illustrating a specific example of a help screen displayed on a display section according to some embodiments;

FIG. 4 is a diagram illustrating a specific example of an operation screen displayed on the display section according to some embodiments;

FIG. 5 is a diagram illustrating a specific example of an on-screen display information according to some embodiments;

FIG. 6 is a diagram illustrating a specific example of correspondence processing information according to some embodiments;

FIG. 7 is a diagram illustrating a specific example of help information according to some embodiments;

FIG. 8 is a block diagram illustrating specific functional components of the user terminal according to some embodiments;

FIG. 9 is an external view for illustrating an example of the overall configuration of an image forming apparatus according to some embodiments;

FIG. 10 is a diagram illustrating a specific example of hardware components of the image forming apparatus according to some embodiments;

FIG. 11 is a diagram illustrating a specific example of functional components of the image forming apparatus according to some embodiments;

FIG. 12 is a view for explaining transition of a display screen of a user terminal 1 in the image forming system according to some embodiments;

FIG. 13 is a flowchart depicting a specific example of the flow of a processing in which the image forming system forms an image with an image forming apparatus 2 according to some embodiments;

FIG. 14 is a diagram illustrating a specific example of the operation screen according to some embodiments;

FIG. 15 is a diagram illustrating a specific example of the operation screen according to some embodiments;

FIG. 16 is a diagram illustrating a specific example of the display screen according to some embodiments;

FIG. 17 is a diagram illustrating a specific example of the operation screen according to some embodiments;

FIG. 18 is a diagram illustrating a specific example of the operation screen according to some embodiments;

FIG. 19 is a diagram illustrating a specific example of a help screen according to some embodiments;

FIG. 20 is a diagram illustrating a specific example of a retrieval screen on the user terminal according to some embodiments;

FIG. 21 is a diagram illustrating a specific example of a screen displaying a retrieval result of a retrieval section according to some embodiments;

FIG. 22 is a diagram illustrating a specific example of highlighting on the display screen according to some embodiments;

FIG. 23 is a diagram illustrating a specific example of the help screen when time elapses since the help screen is displayed by selection of the retrieval result;

FIG. 24 is a diagram illustrating a specific example of the operation screen displaying a selection result of selectable information in the help screen; and

FIG. 25 is a diagram illustrating a specific example of functional components of an image forming apparatus according to a modification.

### DETAILED DESCRIPTION

In accordance with some embodiments, an information processing apparatus comprises a display controller and an input section. The display controller displays an explanation screen for displaying information indicating an operation method of an image forming apparatus and an operation screen for receiving an input instructing an operation relating to an image forming processing of the image forming apparatus on a display section. The input section receives an input of an operation of selecting information displayed on the explanation screen. The display controller displays an operation screen according to the selected information on the display section.

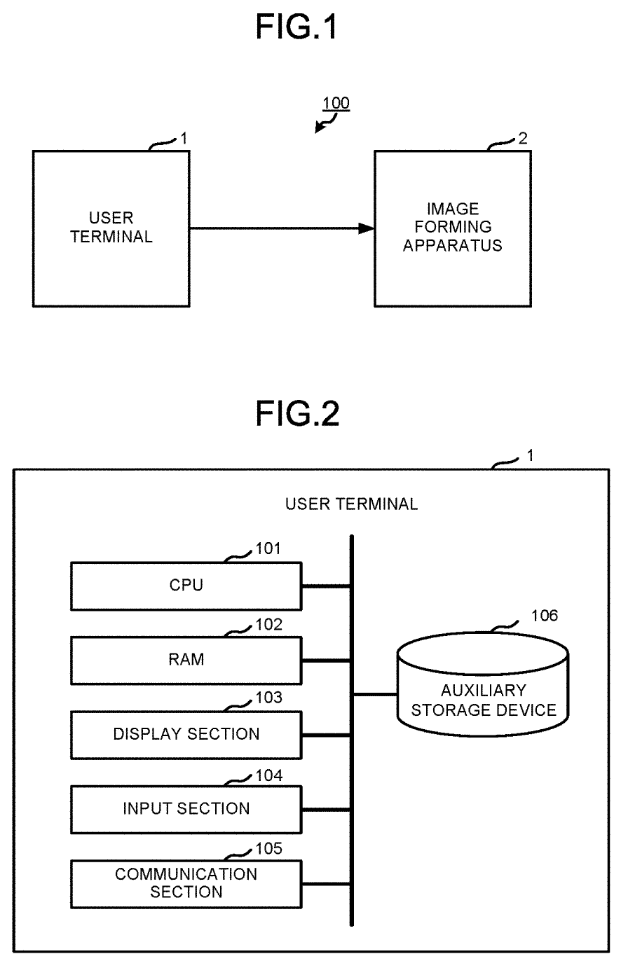

FIG. 1 is a schematic diagram illustrating the outline of the system configuration of an image forming system 100 according to some embodiments. The image forming system 100 comprises a user terminal 1 and an image forming apparatus 2.

The user terminal 1 displays information relating to the use of an image forming processing by the image forming apparatus 2 for a user. The user terminal 1 receives an input by a user. The user terminal 1 generates information about the use of the image forming apparatus 2 based on the input. The user terminal 1 sends the generated information about the use of the image forming apparatus 2 to the image forming apparatus 2. The user terminal 1 displays a screen (hereinafter, referred to as a “help screen”) for displaying information indicating the operation of the image forming apparatus 2. The user terminal 1 displays a screen (hereinafter, referred to as an “operation screen”) for receiving an operation of a user on the image forming apparatus 2. The user terminal 1 displays the help screen if receiving a predetermined operation when the operation screen is displayed. The user terminal 1 displays the operation screen for receiving the operation of the image forming apparatus 2 indicated by the information displayed on the help screen if receiving a predetermined operation when the help screen is displayed.

The image forming apparatus 2 acquires a signal instructing formation of an image transmitted by the user terminal 1 and forms an image based on the acquired signal instructing the image formation.

FIG. 2 is a diagram illustrating a specific example of the hardware components of the user terminal 1 according to the embodiment. The user terminal 1 includes a CPU (Central Processing Unit) 101, a RAM (Random Access Memory) 102, a display section 103, an input section 104, a communication section 105, and an auxiliary storage device 106 which are connected via a bus line.

The display section 103 displays information relating to the image forming apparatus 2. The display section 103 displays the help screen and the operation screen which display information relating to the image forming apparatus 2.

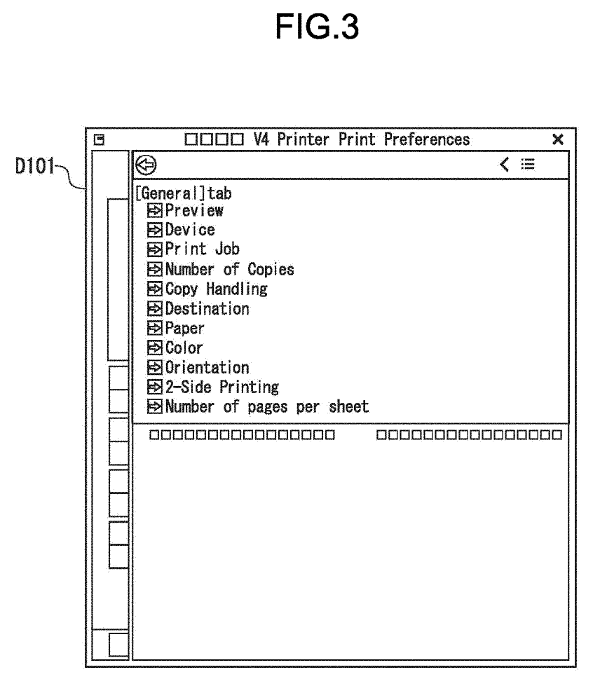

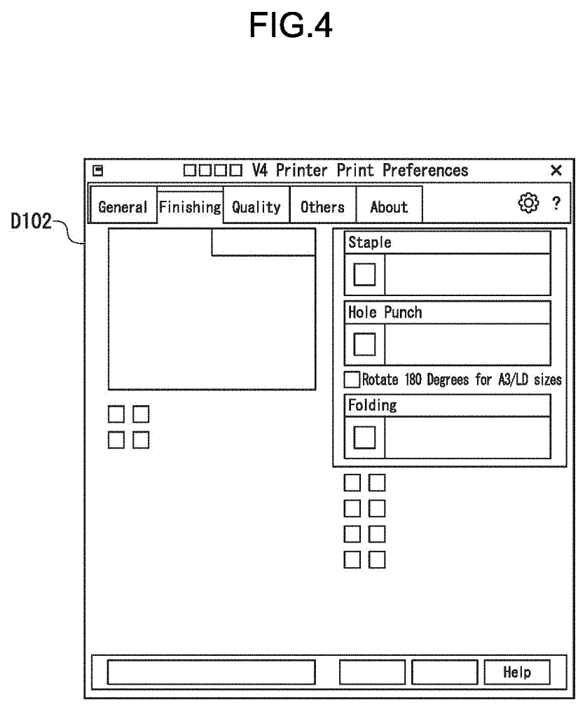

FIG. 3 and FIG. 4 show specific examples of the display screen according to some embodiments.

FIG. 3 is a diagram illustrating a specific example of the help screen displayed on the display section 103 according to the embodiment. A help screen D101 displayed on the display section 103 displays information indicating the operation of the image forming apparatus 2. The help screen D101 displays information indicating that the image forming apparatus 2 executes functions named “Preview”, “Print Job” or “Color”.

FIG. 4 is a diagram illustrating a specific example of the operation screen displayed on the display section 103 according to some embodiments. The operation screen D102 displayed on the display section 103 receives an operation of a user for instructing a predetermined operation to the image forming apparatus 2. The predetermined operation may be a stapling operation, a hole punching operation, a sheet rotation operation, or a folding operation.

Returning to the description in FIG. 2. The input section 104 includes input devices such as a mouse, a keyboard, a touch panel, and the like. The input section 104 may be an interface connecting these input devices to the user terminal 1. The input section 104 receives an input of an operation (hereinafter, referred to as an “image forming operation input”) for the operation relating to the image forming processing of the image forming apparatus 2. The input section 104 outputs the input image forming operation input to the CPU 101.

The communication section 105 includes a communication interface for connecting the user terminal to the image forming apparatus 2. The communication section 105 communicates with the image forming apparatus 2 via the communication interface.

The auxiliary storage device 106 is a storage device such as a magnetic hard disk device or a semiconductor storage device. The auxiliary storage device 106 stores various information. Various information may include, for example, on-screen display information, correspondence processing information and help information. The on-screen display information indicates a correspondence relationship between a screen (hereinafter, referred to as a “display screen”) displayed on the display section 103 and information (hereinafter, referred to as “selectable information”) selectable by the user which is displayed on the screen. The selectable information may be displayed on the display screen in any way. For example, it may be displayed as an icon or a character string on the display screen.

The correspondence processing information indicates a correspondence relationship between the selectable information and a processing executed by the user terminal 1 when the selectable information is selected. The processing executed by the user terminal 1 may be, for example, a processing of changing a display screen, or a processing in which the user terminal 1 transmits a command relating to the image formation to the image forming apparatus 2.

The help information indicates an operation method of the image forming apparatus 2. The help information may be indicated by a character string or a numerical value.

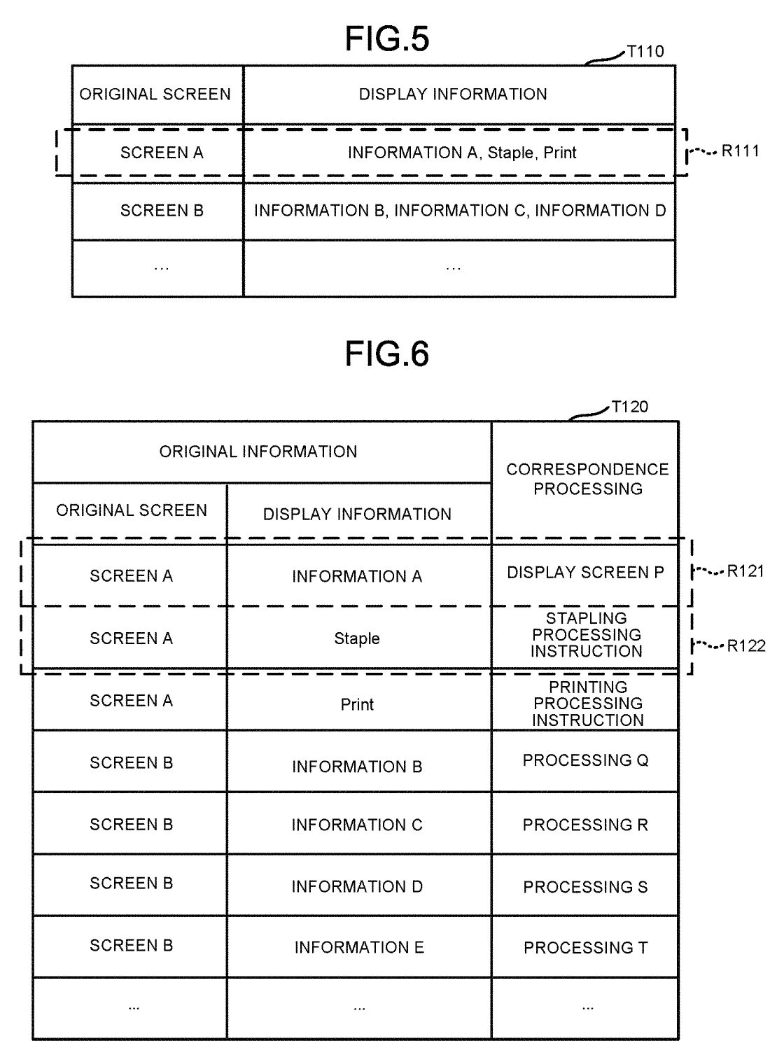

FIG. 5 is a diagram illustrating a specific example of the on-screen display information according to some embodiments. For example, the on-screen display information is stored in the auxiliary storage device 106 as an on-screen display information table T110 shown in FIG. 5. The on-screen display information table T110 has a record for each original screen. Each record has values of an original screen and display information. The original screen indicates a display screen. The display information indicates selectable information displayed on the screen indicated by the corresponding original screen. The display information has a value equal to the amount of the selectable information displayed on the corresponding original screen. For example, a record R111 indicates that three pieces of selectable information including information A, a character string “Staple”, and a character string “Print” are displayed on a screen A. The information A may be the selectable information displayed in any way as long as it is the selectable information. For example, the information A may be the selectable information indicated by a character string, by a numerical value, or by an image.

FIG. 6 is a diagram illustrating a specific example of the correspondence processing information according to some embodiments. The correspondence processing information may be, for example, stored in the auxiliary storage device 106 as a correspondence processing information table T120 shown in FIG. 6. The correspondence processing information table T120 has a record for each original information. Each record has values of original information and corresponding processing. The original information indicates selectable information displayed on the screen indicated by the original screen by two values, i.e., a value indicated by the original screen and a value indicated by the display information. The correspondence processing indicates a content of the processing executed by the user terminal 1 if the information indicated by the corresponding original information is selected by the user. For example, a record R121 indicates that if the user selects the information A which is the selectable information displayed on the screen A, the user terminal 1 executes a processing of displaying a screen P on the display section 103. For example, a record R122 indicates that if the user selects the character string “Staple” which is the selectable information displayed on the screen A, the user terminal 1 instructs the image forming apparatus 2 to execute a stapling processing.

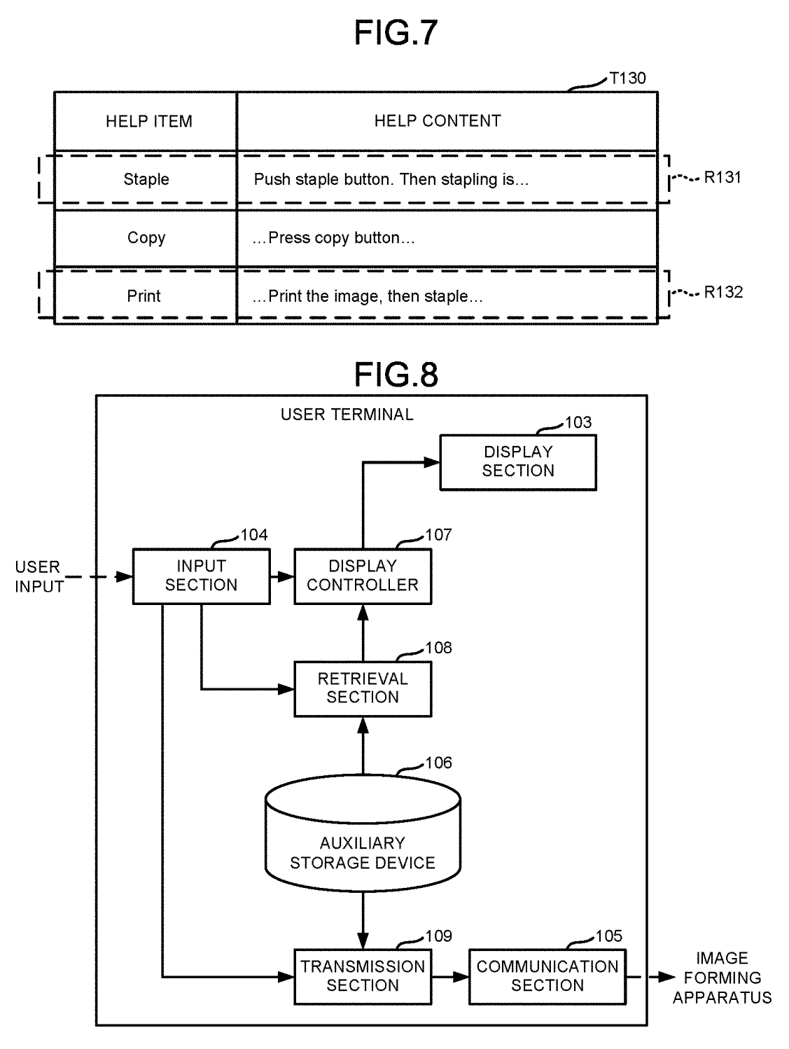

FIG. 7 is a diagram illustrating a specific example of the help information according to some embodiments. For example, the help information may be stored in the auxiliary storage device 106 as a help information table T130 shown in FIG. 7. The help information table T130 includes a character string or a numerical value displayed on the help screen and a content indicated by the character string or the numerical value. The help information table T130 has a record for each help item. Each record has values of a help item and a help content. The help item indicates the selectable information displayed on the display screen by the character string or the numerical value. The help content indicates a content indicated by the corresponding help item. The content indicated by the help content may be indicated by a plurality of character strings or numerical values on the display screen.

For example, a record R131 indicates that a character string or a numerical value associated with the selectable information indicated by a character string “Staple” is a character string “Staple”. For example, a record R132 indicates that a character string or a numerical value associated with a character string “Print” or a numerical value is a character string “Print”.

FIG. 8 is a block diagram illustrating specific functional components of the user terminal 1 according to some embodiments. The CPU 101 reads a program stored in the auxiliary storage device 106 on the RAM 102 and executes it so that the user terminal 1 functions as a device including the display section 103, the input section 104, the communication section 105, the auxiliary storage device 106, a display controller 107, a retrieval section 108 and a transmission section 109.

The display controller 107 controls the display of the screen by the display section 103. The display controller 107 acquires information input to the input section 104 by the user. The display controller 107 generates or updates an image displayed on the display section 103 based on the acquired information.

The display controller 107 displays a retrieval screen if a retrieval screen starting input is input at the user terminal 1 in a case in which the display screen is the help screen. The retrieval screen is a screen on which the user can perform the input. The retrieval screen display input may be any input as long as it instructs the display controller 107 to display the retrieval screen on the display section 103. For example, the retrieval screen starting input may be an input that the user simultaneously presses a predetermined plurality of buttons on a keyboard. For example, the retrieval screen starting input, which is predetermined information on the display screen, may be an input for selecting predetermined information associated with a processing in which the display controller 107 generates or updates the retrieval screen.

The retrieval section 108 selects a predetermined character string or a numerical value from the character strings or the numerical values previously stored in the auxiliary storage device 106 based on the character string or the numerical value input to the retrieval screen of the user terminal 1.

The retrieval section 108 selects a character string or a numerical value coincident with a retrieval keyword from the character strings or the numerical values which are previously stored in the auxiliary storage device 106 and displayable on the help screen. The retrieval section 108 may select a character string or a numerical value exactly coincident with the retrieval keyword. The retrieval section 108 may select a character string or a numerical value partially coincident with the retrieval keyword. The retrieval keyword is a character string or a numerical value input on the retrieval screen. The character strings or numerical values which are previously stored in the auxiliary storage device 106 and displayable on the help screen are, for example, character strings or numerical values indicated by values in the help information table T130 stored in the auxiliary storage device 106.

The transmission section 109 acquires the information input to the input section 104 by the user based on the screen displayed on the display section 103, and transmits the information to the image forming apparatus 2.

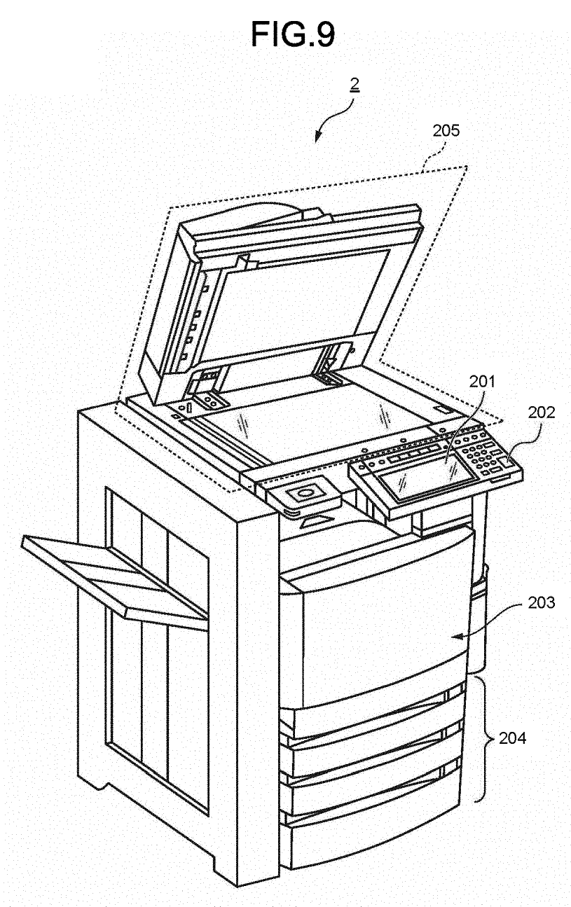

FIG. 9 is an external view for illustrating an example of an overall configuration of an image forming apparatus 2 according to some embodiments. The image forming apparatus 2 is, for example, a multi-functional peripheral. The image forming apparatus 2 includes a display 201, a control panel 202, an image forming section 203, a sheet housing section 204, and an image reading section 205. Furthermore, the image forming section 203 of the image forming apparatus 2 may be a device for fixing a toner image or an inkjet system device.

The image forming apparatus 2 forms an image on a sheet with a developer such as a toner. The sheet is, for example, a paper or a label paper. The sheet may be an optional medium as long as the image forming apparatus 2 can form an image on the surface thereof.

The display 201 is an image display device such as a liquid crystal display, an organic EL (Electro Luminescence) display and the like. The display 201 displays various information relating to the image forming apparatus 2.

The control panel 202 includes a plurality of buttons. The control panel 202 receives an operation by a user. The control panel 202 outputs a signal corresponding to an operation carried out by the user to a controller of the image forming apparatus 2. Furthermore, the display 201 and the control panel 202 may be integrally configured as a touch panel.

The image forming section 203 forms an image on the sheet based on image information generated by the image reading section 205 or image information received via a communication path. The image forming section 203 forms the image by, for example, the following processing. An image forming section of the image forming section 203 forms an electrostatic latent image on a photoconductive drum based on the image information. The image forming section of the image forming section 203 enables the developer to adhere to the electrostatic latent image to form a visible image. Toner is a specific example of the developer. A transfer section of the image forming section 203 transfers the visible image onto the sheet. A fixing section of the image forming section 203 heats and pressurizes the sheet to fix the visible image on the sheet. Furthermore, the sheet on which the image is formed may be a sheet accommodated in the sheet housing section 204 or a manually fed sheet.

The sheet housing section 204 houses the sheet used for the image formation by the image forming section 203.

The image reading section 205 reads the image information of a reading object as intensity of light. The image reading section 205 records the read image information. The recorded image information may be sent to another information processing apparatus via a network. The recorded image information may be used for the image formation on the sheet through the image forming section 203.

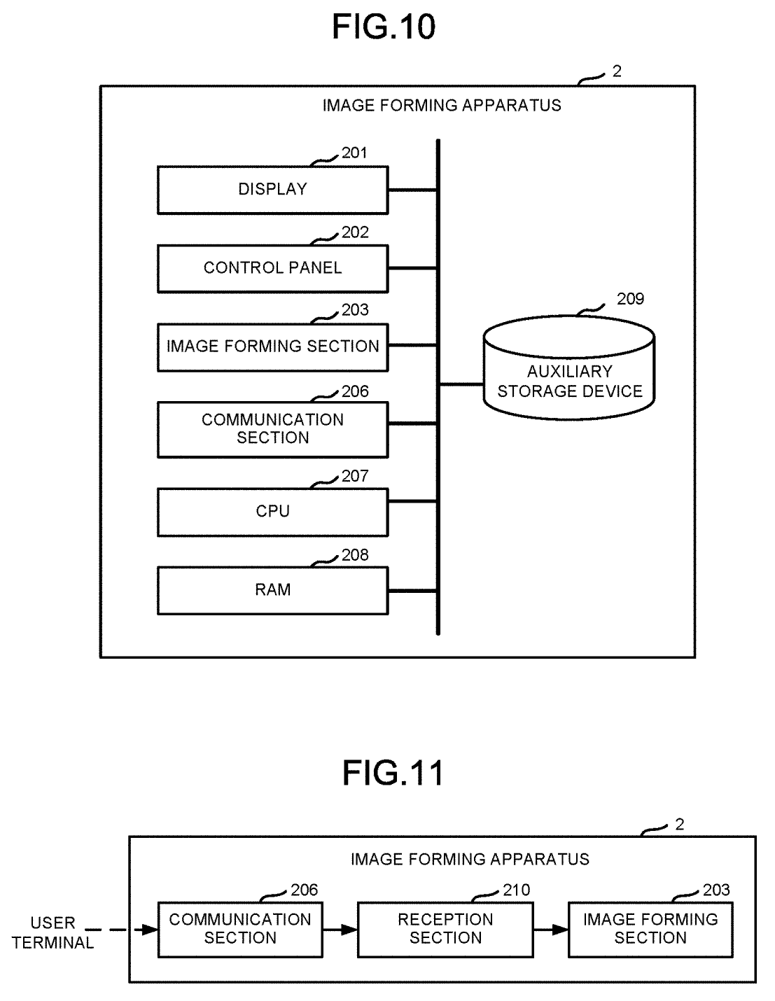

FIG. 10 is a diagram illustrating a specific example of hardware components of the image forming apparatus 2 according to some embodiments. The image forming apparatus 2 includes a CPU (Central Processing Unit) 207, a RAM (Random Access Memory) 208, an auxiliary storage device 209 and the like which are connected by a bus line, and executes a program. The image forming apparatus 2 functions as a device including the display 201, the control panel 202, the image forming section 203, a communication section 206, and the auxiliary storage device 209 by execution of the program.

The communication section 206 includes a communication interface for connecting the image forming apparatus 2 to the user terminal 1. The communication section 206 communicates with the user terminal 1 via the communication interface.

FIG. 11 is a diagram illustrating a specific example of functional components of the image forming apparatus 2 according to some embodiments. The image forming apparatus 2 includes the communication section 206, a reception section 210 and the image forming section 203.

The reception section 210 acquires the information transmitted by the user terminal 1 and outputs the information to the image forming apparatus 2.

If the information acquired by the reception section 210 via the communication section 206 instructs the formation of an image, the image forming section 203 executes the formation of the image according to the information.

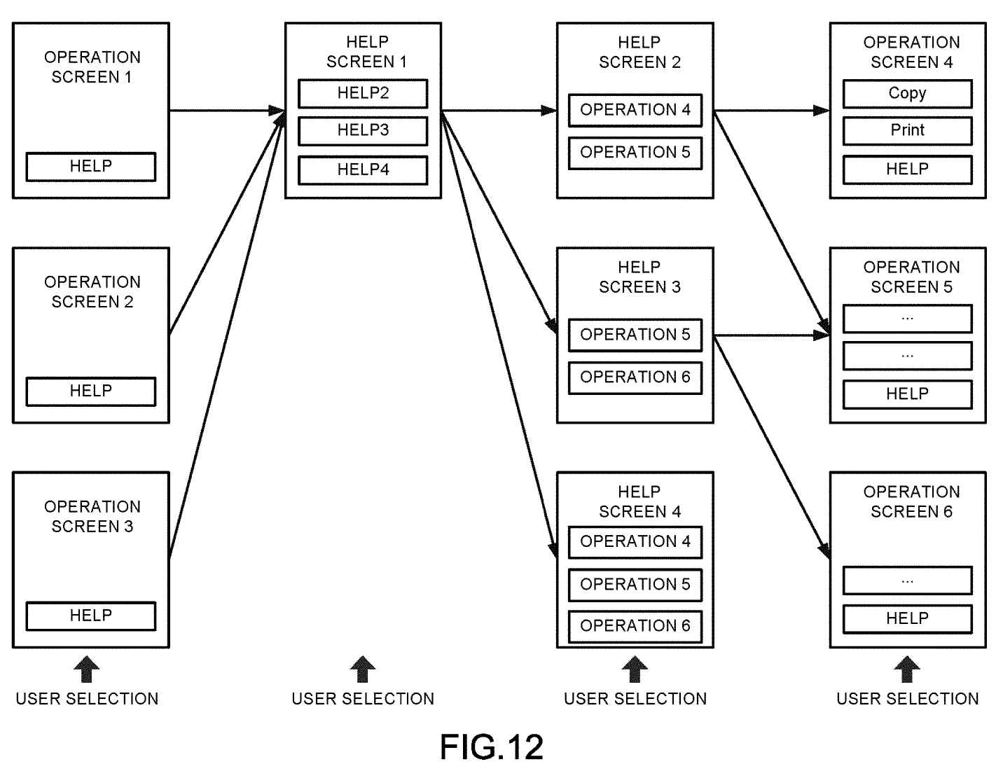

FIG. 12 is a view for explaining the transition of the display screen of the user terminal 1 in the image forming system 100 according to some embodiments. The user terminal 1 changes an image displayed on the display section 103 according to the input by a user.

For example, in a case in which an operation screen 1 displaying a HELP button is displayed on the display section 103, if the HELP button is selected by the input by the user, the help screen 1 is displayed on the display section 103. The HELP button is the selectable information indicated by the character string HELP, and is associated with a processing of displaying the help screen 1 on the display section 103 by the display controller 107. The help screen 1 also displays a HELP 2 button, a HELP 3 button and a HELP 4 button. The HELP 2 button is the selectable information indicated by the character string HELP 2, and is associated with a processing of displaying a help screen 2 on the display section 103 by the display controller 107. The HELP 3 button is the selectable information indicated by the character string HELP 3, and is associated with a processing of displaying a help screen 3 on the display section 103 by the display controller 107. The HELP 4 button is the selectable information indicated by the character string HELP 4, and is associated with a processing of displaying a help screen 4 on the display section 103 by the display controller 107.

For example, in a case in which the help screen 1 is displayed on the display section 103 and the HELP 2 button is selected by the input by the user, the help screen 2 is displayed on the display section 103. The help screen 2 displays an operation 4 button and an operation 5 button. The operation 4 button is the selectable information indicated by the character string operation 4, and is associated with a processing of displaying an operation screen 4 on the display section 103 by the display controller 107. The operation 5 button is the selectable information indicated by the character string operation 5, and is associated with a processing of displaying an operation screen 5 on the display section 103 by the display controller 107.

For example, in a case in which the help screen 2 is displayed on the display section 103 and the operation 4 button is selected by the input by the user, the operation screen 4 is displayed on the display section 103. The operation screen 4 displays a Copy button, a Print button and the HELP button. The Copy button is the selectable information indicated by the character string Copy, and is associated with a copy instruction processing by the user terminal 1. The copy instruction processing is a processing of transmitting a signal instructing copying to the image forming apparatus 2 by the user terminal 1. The Print button is the selectable information indicated by the character string “Print”, and is associated with a printing instruction processing by the user terminal 1. The printing instruction processing is a processing of transmitting a signal instructing printing to the image forming apparatus 2 by the user terminal 1.

In this way, the display screen of the user terminal 1 shifts according to a selection of the user.

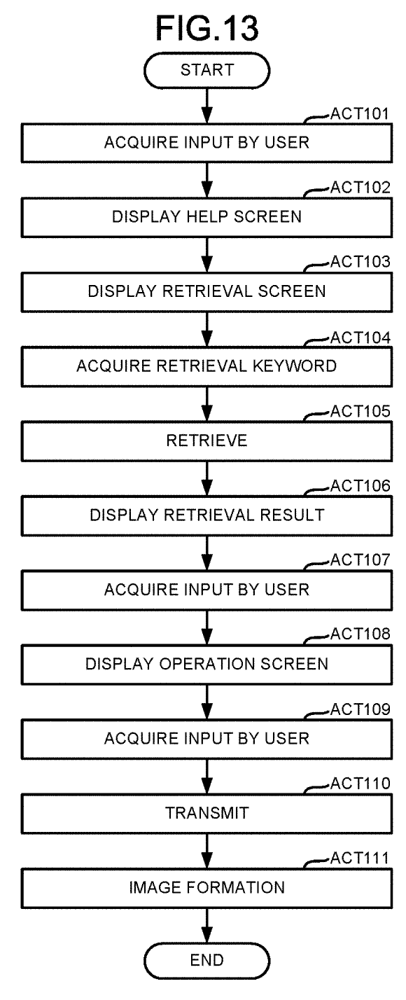

FIG. 13 is a flowchart depicting a specific example of a flow of a processing in which the image forming system 100 forms an image with the image forming apparatus 2 according to some embodiments. Below, for the sake of simplicity, a case in which the retrieval screen is displayed on the display section 103 and the retrieval keyword is input to the retrieval screen is described. A case in which the selectable information indicated by the character string or the numerical value that is a retrieval result based on the retrieval keyword is selected is described. A case in which the processing associated with the selectable information selected in the operation screen is a processing of transmitting the information instructing image formation is described.

The user terminal 1 receives an input (hereinafter, referred to as a “help screen instruction input”) by the user for instructing display of the help screen through the input section 104 (ACT 101). The display controller 107 acquires the help screen instruction input input in the input section 104 and displays the help screen relating to the image forming apparatus 2 on the display section 103 of the user terminal 1 (ACT 102). The help screen instruction input may be any input as long as it is an input by the user for instructing display of the help screen. The help screen instruction input may be, for example, an input for selecting the selectable information associated with a processing of displaying the help screen on the display section 103 by the display controller 107. If receiving the retrieval screen display input by the user, the display controller 107 displays the retrieval screen on the display section 103 (ACT 103). The retrieval section 108 acquires a retrieval keyword designated by the user through the input to the input section 104 (ACT 104). If the retrieval keyword is acquired, the retrieval section 108 refers to the on-screen display information table T110. The retrieval section 108 selects a record in which the screen indicated by the original screen is displayed on the display section 103. The retrieval section 108 acquires the value of the display information in the selected record. Next, the retrieval section 108 refers to the help information table T130. The retrieval section 108 selects a record in which a value indicating the retrieval keyword is contained in the value indicated by the help item or the help content to acquire the value of the help item in the record. The retrieval section 108 acquires a value among the acquired values, wherein a character string or a numerical value indicated by that value is coincident with the character string or the numerical value indicated by the value acquired by referring to the on-screen display information table T110 (ACT 105).

Below, for the sake of simplicity, the processing of the retrieval section 108 in a case in which the help screen displayed on the display section 103 in ACT 102 is the screen A in FIG. 5, and the retrieval keyword is the character string “Staple” is described specifically. The retrieval section 108 first refers to the on-screen display information table T110. The retrieval section 108 selects a record in which the screen indicated by the original screen is the screen A. The retrieval section 108 acquires a value indicating the information A, a value indicating the character string “Staple”, and a value indicating the character string “Print”, which are values of the display information in the retrieved record. The retrieval section 108 refers to the help information table T130. The retrieval section 108 selects a record R131 and a record R132, which include values indicating the character string “Staple” in the help item or the help content. The retrieval section 108 acquires a value indicating the character string “Staple” indicated by the help item of the record R131 and a value indicating the character string “Print” indicated by the help item of the record R132.

The display controller 107 acquires the value acquired by the retrieval section 108 to display the selectable information shown as a character string or a numerical value indicated by the value on the retrieval screen (ACT 106). The user inputs an instruction for selecting the selectable information displayed in ACT 106 to the input sect ion 104 (ACT 107). The display controller 107 executes an operation screen display processing associated with the selectable information selected in ACT 107. The operation screen display processing is a processing of displaying the operation screen associated with the selectable information selected in ACT 107 on the display section 103. In the operation screen display processing, the display controller 107 first refers to the correspondence processing information table T120. In the operation screen display processing, the display controller 107 selects a record in which the selectable information indicated by the original information is the selectable information selected in ACT 107. In the operation screen display processing, the display controller 107 acquires a value of the correspondence screen in the selected record. In the operation screen display processing, the display controller 107 displays the operation screen indicated by the acquired value on the display section 103 (ACT 108).

The transmission section 109 acquires an input for selecting the selectable information displayed on the operation screen displayed in ACT 108 (ACT 109). The transmission section 109 executes a processing associated with the selectable information selected in ACT 109. If the processing associated with the selectable information is a processing of transmitting the information instructing for the image formation, the transmission section 109 transmits the information for instructing the image formation to the image forming apparatus 2 (ACT 110). The image forming apparatus 2 forms an image based on the information acquired in ACT 110 (ACT 111).

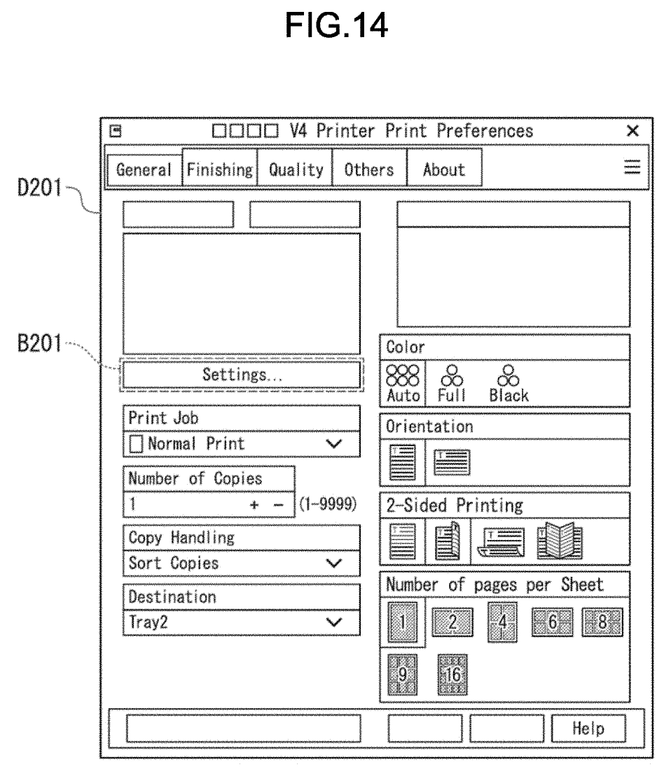

FIG. 14 to FIG. 17 show specific examples of the transition of the screen displayed on the display section 103 according to some embodiments.

FIG. 14 is a diagram illustrating a specific example of the operation screen according to some embodiments. An operation screen D201 in FIG. 14 displays selectable information B201 indicated by the character string “Settings . . . ”. When the selectable information B201 is selected by the user, the display controller 107 executes a processing associated with the selectable information B201 and changes the display screen.

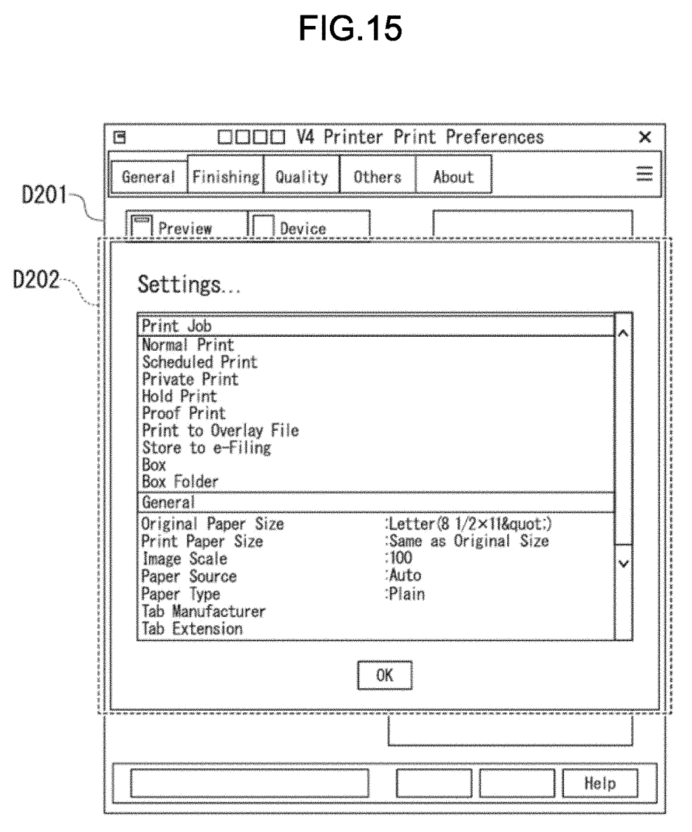

FIG. 15 is a diagram illustrating a specific example of the operation screen displayed by a processing associated with the selectable information B201 in FIG. 14. In an operation screen D202 in FIG. 15, a plurality of the selectable information is listed.

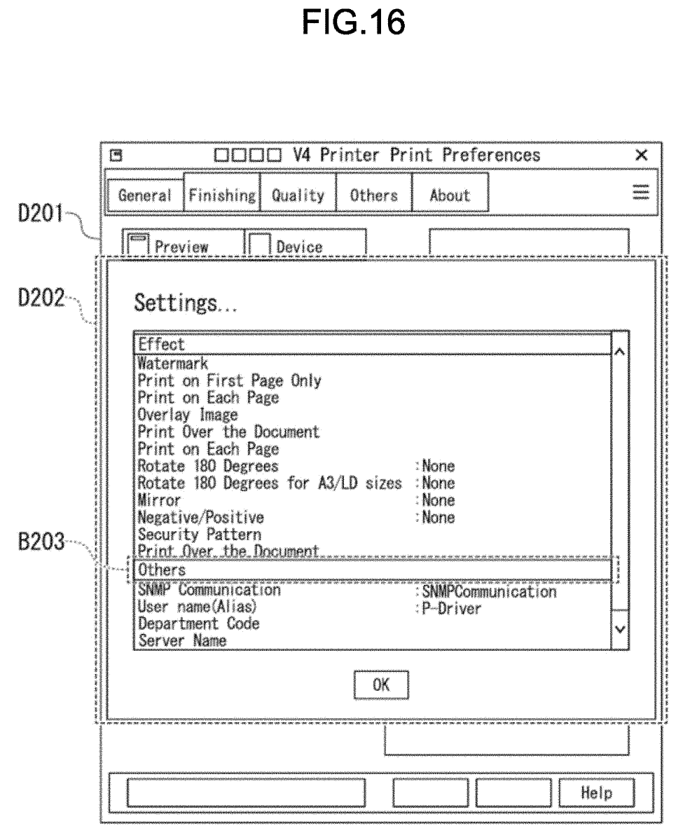

FIG. 16 is a diagram illustrating a specific example of the display screen when the selectable information is selected by the user on the operation screen in FIG. 15. In the operation screen D202, selectable information B203 indicated by the character string “Others” is selected by the user.

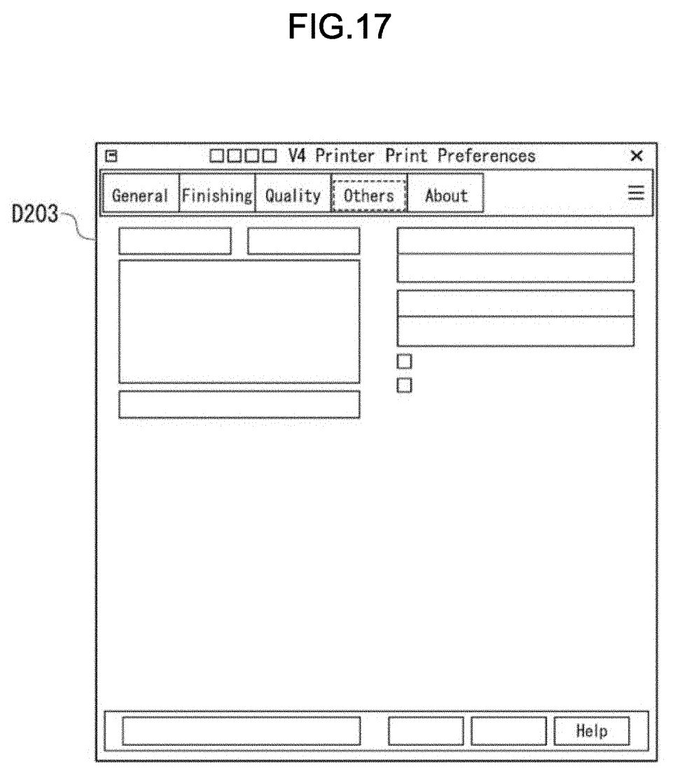

FIG. 17 is a diagram illustrating a specific example of the operation screen displayed by the processing associated with the selectable information B203 according to some embodiments. An operation screen D203 in FIG. 17 is displayed when the selectable information B203 is selected in the operation screen D202 in FIG. 16.

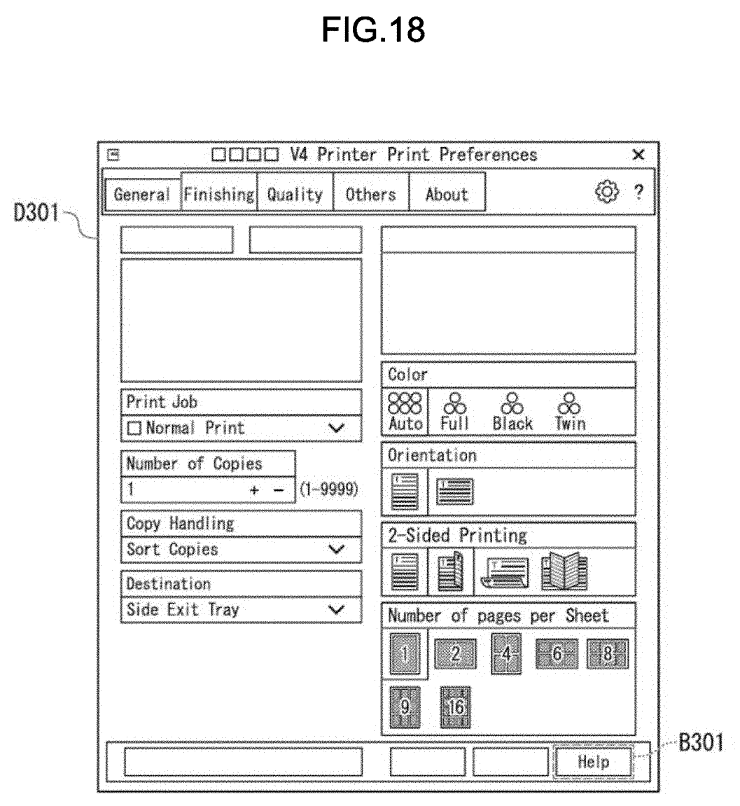

FIG. 18 to FIG. 24 are diagrams illustrating specific examples of the transition of the display screen from when the operation screen is displayed to when the operation screen is displayed via the help screen.

FIG. 18 is a diagram illustrating a specific example of the operation screen according to some embodiments. An operation screen D301 in FIG. 18 displays selectable information B301 indicated by the character string “Help”. When the selectable information B301 is selected by the user, the display controller 107 executes the processing associated with the selectable information B301 to display the help screen on the display section 103.

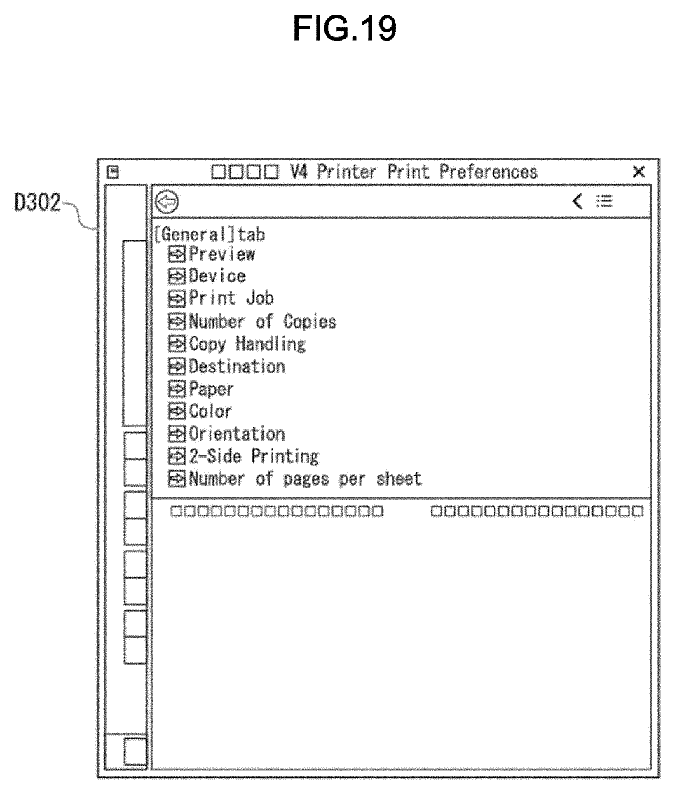

FIG. 19 is a diagram illustrating a specific example of the help screen according to some embodiments. A help screen D302 in FIG. 19 displays information about the operation method of the image forming apparatus 2. More specifically, the help screen D302 displays the operation method of the image forming apparatus 2 by which the user can operate the image forming apparatus 2 in a list form.

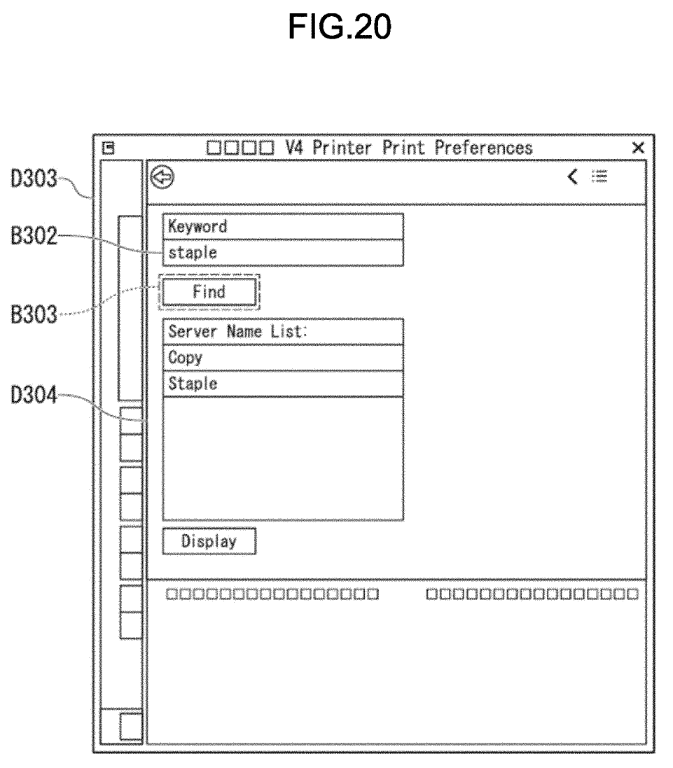

FIG. 20 is a diagram illustrating a specific example of the retrieval screen according to some embodiments. A retrieval screen D304 in FIG. 20 is displayed on the display section 103 together with the help screen D303. The retrieval screen D304 displays selectable information B302 and B303. The selectable information B302 is associated with an input display processing. The input display processing is executed by the display controller 107 when the selectable information B302 is selected by the user. The input display processing is a processing in which the display controller 107 displays a character string or a numerical value input by the user on the display section 103. The selectable information B303 is associated with a processing in which the retrieval section 108 performs the retrieval. When the selectable information B303 is selected, the retrieval section 108 acquires the character string input by the user as the retrieval keyword and starts the retrieval. In FIG. 20, the retrieval keyword is a character string “staple”.

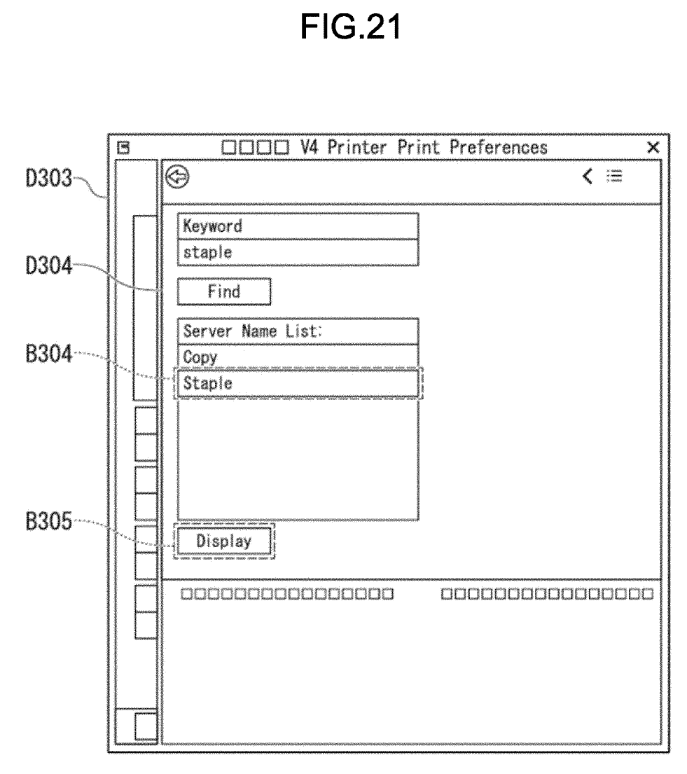

FIG. 21 is a diagram illustrating a specific example of a screen displaying the retrieval result of the retrieval section 108 according to some embodiments. A retrieval screen D304 displays the selectable information which is the retrieval result of the retrieval section 108 in a list form. The retrieval screen D304 displays selectable information B304 and B305. The selectable information B304 is indicated by the character string or the numerical value selected by the retrieval section 108 as a result of the retrieval by the retrieval section 108 using the retrieval keyword. The selectable information B304 is associated with a processing of emphatically displaying the selectable information B304 when selected by an input by the user. Further, the selectable information B304, which is in conjunction with selectable information B305, is also associated with a processing of displaying a predetermined help screen D305 by the display controller 107. If the selectable information B305 is selected by an input by the user in a state in which the selectable information B304 is selected by the user, a processing associated thereto is executed. The processing associated with the selectable information B305 is a processing in which the display controller 107 displays the predetermined help screen D305 associated with the selectable information B304.

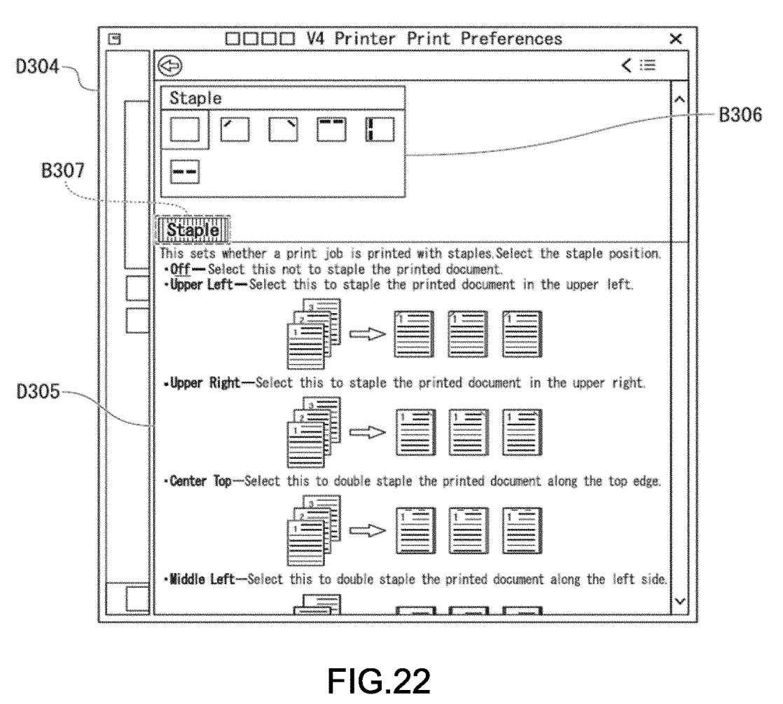

FIG. 22 is a diagram illustrating a specific example of the highlighting on the display screen according to some embodiments. The help screen D305 in FIG. 22 is displayed as a result of selecting the selectable information B304 and B305 in FIG. 21 by an input by the user. The help screen D305 displays selectable information B307. When the selectable information B306 is selected by the input by the user, an operation screen D306 is displayed on the display section 103. In the help screen D305, a character string B307 “Staple” which is the retrieval keyword in FIG. 21 is emphatically displayed.

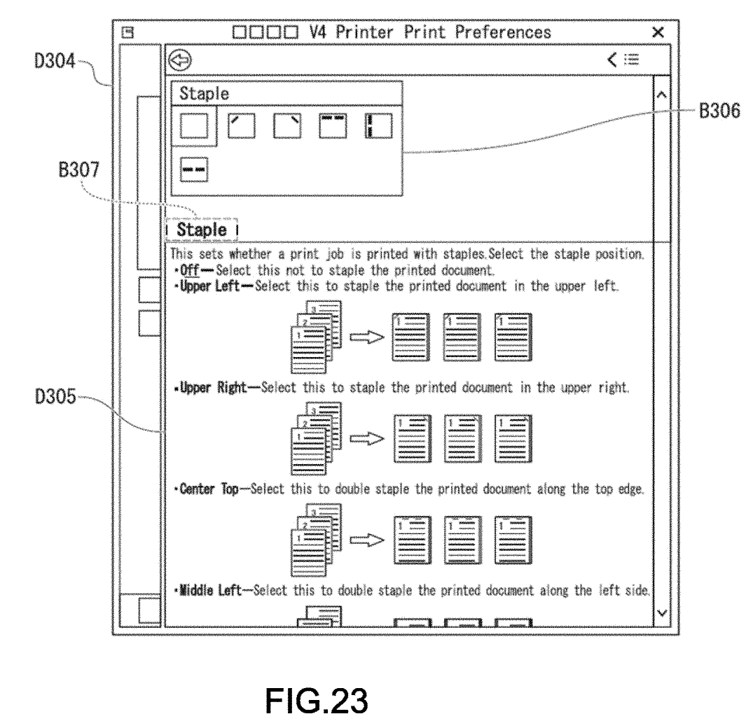

FIG. 23 is a diagram illustrating a specific example of the help screen when the time elapses since the help screen is displayed by selection of the retrieval result. FIG. 23 is the help screen D305 when a predetermined time elapses since the help screen D305 is displayed. The display of the character string B307 “Staple” emphatically displayed in FIG. 22 is no longer emphatically displayed if the time elapses.

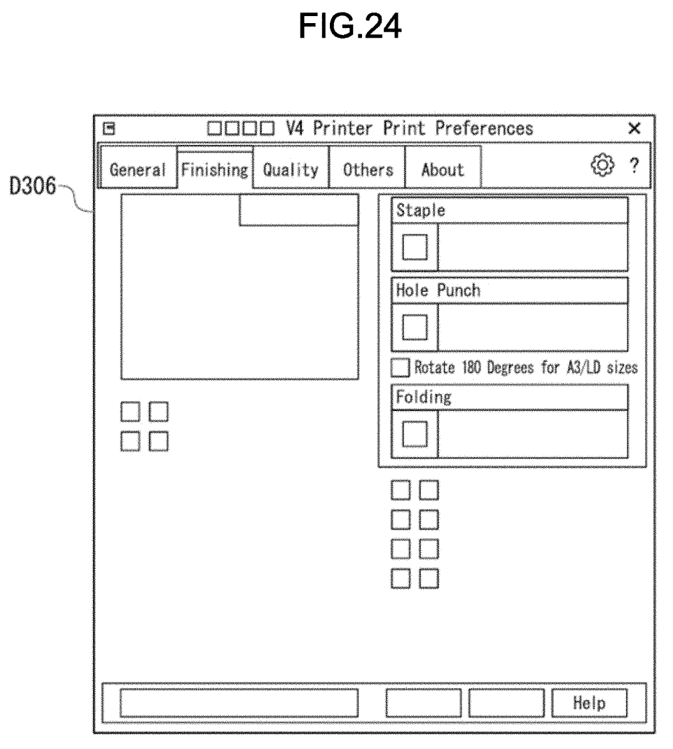

FIG. 24 is a diagram illustrating a specific example of the operation screen displayed as a result of selecting the selectable information in the help screen. When the selectable information B306 is selected in FIG. 22 or FIG. 23, the operation screen D306 in FIG. 24 is displayed.

The user terminal 1 constructed in this manner displays the operation screen desired by the user according to the input by the user in the help screen. Therefore, the user terminal 1 can reduce the burden of a user in searching for the operation screen for instructing the image forming apparatus to perform the desired operation.

(Modification)

The display controller 107 and the retrieval section 108 of the user terminal 1 may be provided by the image forming apparatus 2.

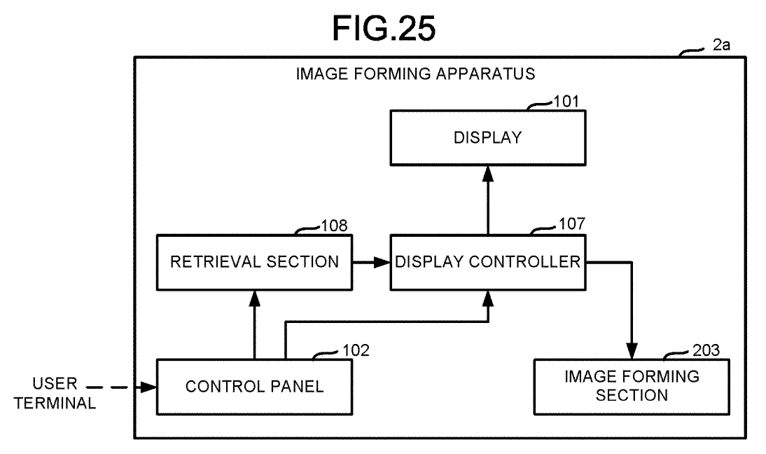

FIG. 25 is a diagram illustrating a specific example of functional components of an image forming apparatus 2a according to a modification. The image forming apparatus 2a is different from the image forming apparatus 2 in that it comprises the display controller 107 and the retrieval section 108. Those having the same functions as the embodiment are denoted with same reference numerals as in FIG. 2, FIG. 7, FIG. 9 and FIG. 10, and the description thereof is omitted. The image forming apparatus 2a includes the display controller 107 and the retrieval section 108, and can achieve the same effect as the image forming apparatus 2 according to the embodiment.

The help screen in the above embodiment is an example of an explanation screen. The user terminal 1 and the image forming apparatus 2a are an example of the information processing apparatus. The auxiliary storage device 106 is an example of a storage section.

All or a part of the functions of the user terminal 1, the image forming apparatus 2 and the image forming apparatus 2a may be realized by using hardware such as an ASIC (Application Specific Integrated Circuit), a PLD (Programmable Logic Device), a FPGA (Field Programmable Gate Array). The program may be recorded on a computer-readable recording medium. The computer-readable recording medium is, for example, a portable medium such as a flexible disk, a magneto-optical disk, a ROM, a CD-ROM, or the like, or a storage device such as a hard disk built in a computer system. The program may be transmitted via an electric communication line.

According to at least one embodiment described above, in response to an input by the user in the help screen, an operation screen that the user desires is displayed without operating respective operation screens by the user from an operation screen in an upper order to an operation screen in a lower order. Therefore, the user terminal 1 can reduce the burden of a user in searching for the operation screen for instructing the image forming apparatus to perform the desired operation.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and their equivalents are intended to cover such forms or modifications as would fall within the scope and spirit of the invention.

1. An information processing apparatus, comprising:
a display section;
a display controller configured to display an explanation screen for displaying information indicating an operation method of an image forming apparatus on the display section, and to display an operation screen for receiving an input instructing an operation to the image forming apparatus on the display section, wherein the information displayed on the explanation screen includes an information indicating a predetermined operation to the image forming apparatus, and the information indicating the predetermined operation is displayed so as to be selectable; and
a storage section configured to store information indicating a correspondence relationship between the information indicating the predetermined operation displayed on the explanation screen and the operation screen for receiving an input instructing the predetermined operation;
an input section configured to receive an input of an operation of selecting the information indicating the predetermined operation displayed on the explanation screen, wherein
the display controller is configured to display the operation screen according to an input of selecting the information indicating the predetermined operation based on the information indicating the correspondence relationship.

2. The information processing apparatus according to claim 1, wherein
the storage section stores the information indicating the correspondence relationship between a character string or a numerical value indicating the predetermined operation displayed on the explanation screen and the operation screen displayed on the display section by the display controller, wherein
the display controller is configured to display the operation screen according to an input of selecting the character string or a numerical value indicating the predetermined operation based on the information indicating the correspondence relationship.

3. The information processing apparatus according to claim 1, further comprising:
a retrieval section configured to receive input of designating a character string or a numerical value, and to retrieve character strings or numerical values displayed on the explanation screen, wherein
the display controller is configured to:
display a character string or a numerical value acquired by the retrieval section on the display section, and
display an operation screen corresponding to the character string or the numerical value on the display section in response to an input of selecting a predetermined character string or a numerical value among the acquired character strings or numerical values.

4. The information processing apparatus according to claim 3, wherein
the display controller is configured to emphatically display a retrieval result retrieved by the retrieval section.

5. An information processing method, comprising:
displaying an explanation screen for displaying information indicating an operation method of an image forming apparatus and an operation screen for receiving an input instructing an operation to the image forming apparatus on a display section, wherein the information displayed on the explanation screen includes an information indicating a predetermined operation to the image forming apparatus, and the information indicating the predetermined operation is displayed so as to be selectable, the image forming apparatus including a storage section configured to store information indicating a correspondence relationship between the information indicating the predetermined operation displayed on the explanation screen and the operation screen for receiving an input instructing the predetermined operation;
receiving an input of an operation of selecting the information indicating the predetermined operation displayed on the explanation screen; and
displaying the operation screen according to an input of selecting the information indicating the predetermined operation based on the information indicating the correspondence relationship.

6. The method according to claim 5, further comprising:
storing the information indicating the correspondence relationship between a character string or a numerical value indicating the predetermined operation displayed on the explanation screen and the operation screen displayed on the display section; and
displaying the operation screen according to an input of selecting the character string or a numerical value indicating the predetermined operation based on the information indicating the correspondence relationship.

7. The method according to claim 5, further comprising:
receiving input of designating a character string or a numerical value, and retrieving character strings or numerical values displayed on the explanation screen;
displaying a character string or a numerical value acquired by the retrieval section on the display section; and
displaying an operation screen corresponding to the character string or the numerical value on the display section in response to an input of selecting a predetermined character string or a numerical value among the acquired character strings or numerical values.

8. The method according to claim 7, wherein a retrieval result retrieved is emphatically displayed on the display section.

9. A non-transitory recording medium storing a program, which when executed by a computer, causes the computer to perform a method comprising:
displaying an explanation screen for displaying information indicating an operation method of an image forming apparatus and an operation screen for receiving an input instructing an operation to the image forming apparatus on a display section, wherein the information displayed on the explanation screen includes an information indicating a predetermined operation to the image forming apparatus, and the information indicating the predetermined operation is displayed so as to be selectable, the image forming apparatus including a storage section configured to store information indicating a correspondence relationship between the information indicating the predetermined operation displayed on the explanation screen and the operation screen for receiving an input instructing the predetermined operation;
receiving an input of an operation of selecting the information indicating the predetermined operation displayed on the explanation screen; and
displaying the operation screen according to an input of selecting the information indicating the predetermined operation based on the information indicating the correspondence relationship.

10. The non-transitory recording medium according to claim 9, the method further comprising:
storing the information indicating the correspondence relationship between a character string or a numerical value indicating the predetermined operation displayed on the explanation screen and the operation screen displayed on the display section; and
displaying the operation screen according to an input of selecting the character string or a numerical value indicating the predetermined operation based on the information indicating the correspondence relationship.

11. The non-transitory recording medium according to claim 9, the method further comprising:
receiving input of designating a character string or a numerical value, and retrieving character strings or numerical values displayed on the explanation screen;
displaying a character string or a numerical value acquired by the retrieval section on the display section; and
displaying an operation screen corresponding to the character string or the numerical value on the display section in response to an input of selecting a predetermined character string or a numerical value among the acquired character strings or numerical values.

12. The non-transitory recording medium according to claim 11, wherein a retrieval result retrieved is emphatically displayed on the display section.
